(19) United States
(12) Patent Application Publication
(10) Pub. No.: US 2017/0142319 A1
(43) Pub. Date: May 18, 2017

(54) REMOTE CONTROLLER OF DIGITAL VIDEO CAMERA

(71) Applicant: Nihon Video System Co., Ltd., Tsushima-shi (JP)

(72) Inventors: Kentaro Hashiguchi, Tsushima-shi (JP); Hidetake Sugita, Tsushima-shi (JP); Shinji Yuki, Tsushima-shi (JP); Hung Cheng Kung, Koshigaya-shi (JP)

(73) Assignee: Nihon Video System Co., Ltd., Tsushima-shi (JP)

(21) Appl. No.: 15/353,654

(22) Filed: Nov. 16, 2016

(30) Foreign Application Priority Data
Nov. 17, 2015 (JP) 2015-225192

(51) Int. Cl. H04N 5/232

(52) U.S. Cl. CPC H04N 5/23203; H04N 5/23296

(57) ABSTRACT

A single remote controller is provided that is capable of automatically determining a digital or analog control method as a remote controller control method for digital video cameras. According to the present invention, a remote controller for a digital video camera is provided that includes: a zoom volume configured to operate zoom of the digital video camera; a microcomputer circuit configured to convert an operation signal of the zoom volume to a communication signal; and an automatic switching circuit configured to automatically switch between sending of the operation signal of the zoom volume to the digital video camera not through the microcomputer circuit and sending of the communication signal, obtained by inputting the operation signal to the microcomputer circuit, to the digital video camera.

### TECHNICAL FIELD

The present invention relates to a device remotely controlling a digital video camera.

### BACKGROUND ART

Remote control of digital video cameras these days includes both the type, called LANC® (referred to as communication control), controlling with a communication signal by a microcomputer circuit and the type (referred to as direct control) directly controlling by a volume and a switch, the types being dependent on manufacturers of the digital video cameras, and they have to be switched by a remote controller or a switch matching respectively (see NPLs 1 and 2).

### CITATION LIST

### Non-Patent Literature

NPL 1: http://www.varizoom.com/focus-zoom-camera-lens-controls-s/1814.htm

NPL 2: http://www.libec.co.jp/products/remote_controls/remote_controls.html

### SUMMARY OF THE INVENTION

### Technical Problem

Unfortunately, no remote controller has yet been achieved that is automatically compatible with any of the above control methods, while there is a strong expectation by users.

In view of the above situation, it is an object of the present invention to provide a single remote controller that is automatically compatible with digital video camera control methods, different for each manufacturer, without being manually switched.

### Solution to Problem

According to the present invention, a remote controller for a digital video camera is provided that includes: a zoom volume configured to operate zoom of the digital video camera; a microcomputer circuit configured to convert an operation signal of the zoom volume to a communication signal; and an automatic switching circuit configured to automatically switch between sending of the operation signal of the zoom volume to the digital video camera not through the microcomputer circuit and sending of the communication signal, obtained by inputting the operation signal to the microcomputer circuit, to the digital video camera.

According to the invention, an automatic determining circuit is capable of switching between direct transmission of an operation signal by a switch and transmission of a communication signal by a microcomputer circuit. The invention thus achieves one remote controller allowing appropriate zooming compatible with two types, direct control and communication control, of digital video cameras by a user in use.

Preferably, the automatic switching circuit determines whether the controller is connected to a communication-control camera or connected to a direct-control camera by a voltage detection circuit inside the zoom remote controller to automatically switch between connection of a predetermined pin of a connector of the remote controller to a power supply input of the microcomputer circuit and connection to the zoom volume.

The present inventor found that approximately 6 V is supplied to a second top pin (hereinafter, “a power supply pin”) of a connector ST1 in FIG. 1 of the present invention while a communication-control video camera is connected and approximately 1.5 V is supplied to the power supply pin when a direct-control video camera is connected. That is, a voltage is supplied to the power supply pin of the connector ST1 in either case where the control method of the video camera connected to the connector ST1 is communication control or direct control, whereas the supplied voltage is different in magnitude.

Based on the findings, it has been made possible, by configuring the power supply pin of the connector ST1 to be switched between connection to a power supply pin of a microcomputer circuit IC1 and connection to a zoom volume VR1, to appropriately power-supply to the microcomputer circuit IC1 when the communication-control video camera is connected to the connector ST1, and to appropriately read the resistance of the zoom volume VR1 when the direct-control video camera is connected to the connector ST1.

### BRIEF DESCRIPTION OF THE DRAWINGS

FIG. 1 is a schematic circuit diagram illustrating an embodiment of the present invention.

### DESCRIPTION OF EMBODIMENTS

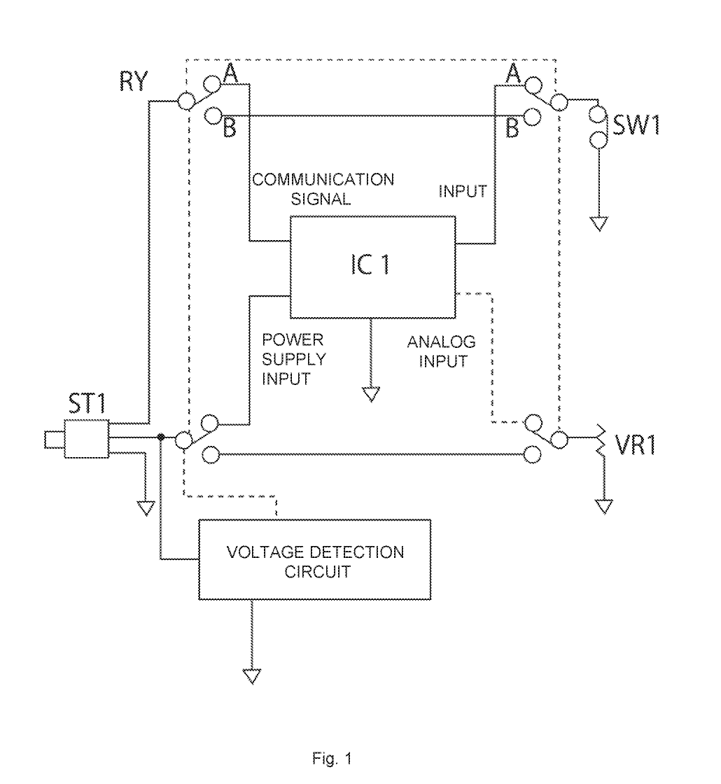

In FIG. 1, SW1 is a start/stop switch to operate start/stop of replay, recording, and the like of a digital video camera (hereinafter, abbreviated as a DV camera), VR1 is a zoom volume composed of a variable resistance element to operate digital and optical zoom of the DV camera, IC1 is a microcomputer circuit to convert an operation signal of the start/stop switch SW1 and the zoom volume VR1 to a communication signal, and RY is an automatic switching circuit to switch by determining whether the controller is connected to a communication-control DV camera or connected to a direct-control DV camera by a voltage detection circuit inside the zoom remote controller and then determining whether to send an operation signal of the start/stop switch SW1 and the zoom volume VR1 to the DV camera not through the microcomputer circuit IC1 or send a communication signal obtained by input to the microcomputer circuit IC1 to the DV camera. ST1 is a remote connector to send each signal to the DV camera by wired connection with a connector on the DV camera. The automatic switching circuit RY automatically switches between connection of a predetermined pin (second top pin) of the connector ST1 to a power supply input of the microcomputer circuit IC1 and connection to the zoom volume VR1.

In this configuration, first, to remotely control a LANC communication-control DV camera, the voltage of an input pin is read and the RY is on an A side (illustrated state) to supply power to the microcomputer circuit IC1 and allow input of an operation signal of the start/stop switch SW1 and the zoom volume VR1. Then, when the start/stop switch SW1 or the zoom volume VR1 is operated by a user, its signal is input to the microcomputer circuit IC1 and is converted to a communication signal indicating start/stop in accordance with the input or a communication signal indicating wide-angle W/telephoto T zoom to be sent to the DV camera through a connection cable, not shown, from a remote connector ST1. A volume operation signal is converted to a communication signal by calculating, for example, a variation of the operation signal.

In contrast, to remotely control a direct-control DV camera, the RY is on a B side to flow an operation signal of the start/stop switch SW1 and the zoom volume VR1 to the remote connector ST1 not through the microcomputer circuit. Then, in user operation, the operation signal of the start/stop switch SW1 and the zoom volume VR1 is directly sent to the DV camera through the connection cable from the remote connector ST1.

This allows a user to remotely control two types, communication control and direct control, of DV cameras using one remote controller only by inserting the remote controller into a camera, that is, to share one remote controller for two types of digital video.

The above embodiment in FIG. 1 includes both the start/stop switch SW1 and the zoom volume VR1. Meanwhile, it is naturally understood that a remote controller may be constructed by including either one of them to control either one of zoom or start/stop.

It is also naturally understood that the remote connector ST1 may separately include a connector dedicated for direct-control DV cameras to directly send an operation signal and a connector dedicated for communication-control DV cameras to send a communication signal obtained by being converted by the microcomputer circuit.

The circuit in FIG. 1 may be stored in a housing and provided with a start/stop operation unit corresponding to the start/stop switch SW1, a zoom operation unit corresponding to the zoom volume VR1, and a switching operation unit corresponding to a switch SW2.

An integrated device is thus achieved that has the housing with a built-in substrate of the above circuit configuration and each operation unit arranged in an appropriate position. Such a compact and inexpensive single remote controller is capable of remotely controlling respective DV cameras of two types of control methods.

Although the circuit is switched using the relays in the above embodiment, it may be switched using, instead of the relays, FITs and transistors. It may be switched by software.

### REFERENCE SIGNS LIST

SW1 Start/Stop Switch
VR1 Zoom Volume
IC1 Microcomputer Circuit
RY Relay (Switching Circuit)
ST1 Remote Connector

1. A remote controller for a digital video camera, comprising:
a zoom volume configured to operate zoom of the digital video camera;
a microcomputer circuit configured to convert an operation signal of the zoom volume to a communication signal; and
an automatic switching circuit configured to automatically switch between sending of the operation signal of the zoom volume to the digital video camera not through the microcomputer circuit and sending of the communication signal, obtained by inputting the operation signal to the microcomputer circuit, to the digital video camera.

2. The remote controller of claim 1, wherein the automatic switching circuit determines whether the controller is connected to a communication-control camera or connected to a direct-control camera by a voltage detection circuit inside the zoom remote controller to automatically switch between connection of a predetermined pin of a connector of the remote controller to a power supply input of the microcomputer circuit and connection to the zoom volume.
